(19) United States
(12) Patent Application Publication
(10) Pub. No.: US 2019/0057349 A1
(43) Pub. Date: Feb. 21, 2019

(54) DROP SHIPPING SYSTEM

(71) Applicant: Global Market Group(guangzhou)Co., Ltd., Guangzhou (CN)

(72) Inventor: Weijia Pan, Foshan (CN)

(21) Appl. No.: 15/906,970

(22) Filed: Feb. 27, 2018

(30) Foreign Application Priority Data
Aug. 16, 2017 (CN) 201710702322.4

(51) Int. Cl. G06Q 10/08; G06Q 30/06

(52) U.S. Cl. CPC G06Q 10/0835; G06Q 10/087; G06Q 30/0619

(57) ABSTRACT

The present invention relates to a drop shipping system, whereas said drop shipping platform communicates with the storage and distribution service company, online store, e-commerce platform and brand trader via an API interface; brand trader uploads the commodity information onto the drop shipping platform; the brand trader stocks up to the storage and distribution service company; the online store owner selects the commodity to be sold on the drop shipping platform based on the commodity information, and uploads the commodity information of the selected commodity onto the online store on the e-commerce platform with one click. The system reduces labor costs and time, and improves economic efficiency by reducing manual handling. The system enables the brand trader to receive services from numerous online store owners by reducing working costs of online store owners dramatically.

### PRIORITY CLAIM

This application claims the benefit of the filing date of Chinese Patent Application Serial No. 201710702322.4, filed Aug. 16, 2017, for “A Drop Shipping System.”

### TECHNICAL FIELD

The present invention relates to the technosphere of e-commerce, especially to a drop shipping system.

### BACKGROUND

Drop shipping is a new e-commerce pattern, where a retailer realizes zero-purchase sale using product information, and a supplier realizes small-amount order sale using channels, i.e., a brand trader sells commodities under its own brand via a large number of B2C online stores through a series of information processing operations.

A drop shipping system is based mainly on a drop shipping platform that integrates a number of third party platforms, such as storage management platform, logistics delivery platform, logistics tracking platform, online store platform, brand trader and payment gateway, into a complete distribution system. In existing drop shipping systems, numerous intermediate operations and extensive manual handling are needed from order placing by the buyer to order completion, resulting in high labor costs and low operating efficiency.

### BRIEF SUMMARY

In view of this, it is necessary to provide a drop shipping system to aim at the problems of high labor costs and low operating efficiency.

a drop shipping system, comprising drop shipping platform, storage and distribution service company, online store, e-commerce platform and brand trader; said drop shipping platform communicates with the storage and distribution service company, online store, e-commerce platform and brand trader via an API interface; the brand trader uploads the commodity information onto the drop shipping platform; the brand trader stocks up to the storage and distribution service company; the online store owner selects the commodity to be sold on the drop shipping platform based on the commodity information, and uploads the commodity information of the selected commodity onto the online store on the e-commerce platform with one click; the consumer places an order and pays, and the order is sent to the drop shipping platform; the online store pays the order sum to the drop shipping platform; the drop shipping platform sends the delivery information to the storage and distribution service company; the storage and distribution service company delivers the commodity to the consumer based on the delivery information; the drop shipping platform pays the order sum to the brand trader to complete the transaction.

Preferably, the procedure after the drop shipping platform pays the order sum to the brand trader also includes: The brand trader pays the distribution fee to the storage and distribution service company.

Preferably, the procedure that the brand trader uploads the commodity information onto the drop shipping platform includes: The brand trader pushes the commodity ID to the drop shipping platform, and the ID of said commodity is correlated with the commodity information in advance.

Preferably, the procedure that the online store owner selects the commodity to be sold on the drop shipping platform based on the commodity information, and uploads the commodity information of the selected commodity onto the online store on the e-commerce platform with one click includes: It is judged if the commodity quantity of the current storage and distribution service company meets the preset quantity; if the commodity quantity of the current storage and distribution service company meets the preset quantity, the mall platform interfacing with the drop shipping platform will be differentiated; the commodity message is acquired based on all information of said commodity; the commodity message is synchronized with the corresponding online store on the e-commerce platform according to the criteria and requirements for commodity information of the e-commerce platform.

Preferably, the procedure that the order is sent to the drop shipping platform includes: The drop shipping platform pulls the paid order of the online store at the set time through the preset rules.

Preferably, the procedure that the drop shipping platform sends the delivery information to the storage and distribution service company includes: the drop shipping platform converts paid orders of different online stores within the same period into sales orders; the drop shipping platform takes apart orders by brand traders to which commodities on sales orders belong; the drop shipping platform notifies the storage and distribution service company for delivery, obtains logistics tracking number, and pushes it to the online store.

Preferably, the procedure that the brand trader stocks up to the storage and distribution service company includes: The drop shipping platform returns a commodity barcode based on the commodity information; the brand trader affixes the printed commodity barcode to the outer package of the commodity; the brand trader stocks the commodity affixed with the commodity barcode up to the storage and distribution service company; the storage and distribution service company updates the inventory information, and sends the updated inventory information to the drop shipping platform.

Preferably, it also includes: The drop shipping platform reallocates the inventory based on the updated inventory information, and sends the latest inventory information to the e-commerce platform.

Preferably, the procedure before the step that the online store owner selects the commodity to be sold on the drop shipping platform based on the commodity information also includes: the online store logs into the e-commerce platform to push the authorization information to the drop shipping platform; the drop shipping platform accepts the authorization to tie in with the online store.

The above drop shipping system enables the brand trader to sell commodities under its own brand via a large number of B2C online stores through a series of information processing operations. The system uses API interfacing extensively, and integrates a number of third party platforms, such as storage management platform, logistics delivery platform, logistics tracking platform, online store platform, brand trader and payment gateway, into a complete distribution system; it also uses mobile devices and instant messaging to enable participants of all systems to work on the basis of automatic coordination, realizing a stable, efficient and accurate workflow. The system reduces labor costs and time, and improves economic efficiency by reducing manual handling. The system enables the brand trader to receive services from numerous online store owners by reducing working costs of online store owners dramatically.

### BRIEF DESCRIPTION OF THE DRAWINGS

FIG. 1 is a schematic structural diagram of the drop shipping system in an embodiment; and

FIG. 2 is a schematic flow diagram of the drop shipping system in an embodiment.

### DETAILED DESCRIPTION

The drop shipping platform of the present invention is GMDropship, which is an intelligent cross-border e-commerce drop shipping service platform that integrates premium brand traders and overseas e-commerce platform vendors, and provides users with core cross-border trading services, such as storage and logistics, payment and settlement, and automatic B2C platform interfacing. Its operating pattern is a globally original automatic trading pattern. The e-commerce platform is a B2C e-commerce platform, including without limitation eBay and Amazon. The storage and distribution service company is responsible mainly for storage management, logistics delivery and logistics tracking.

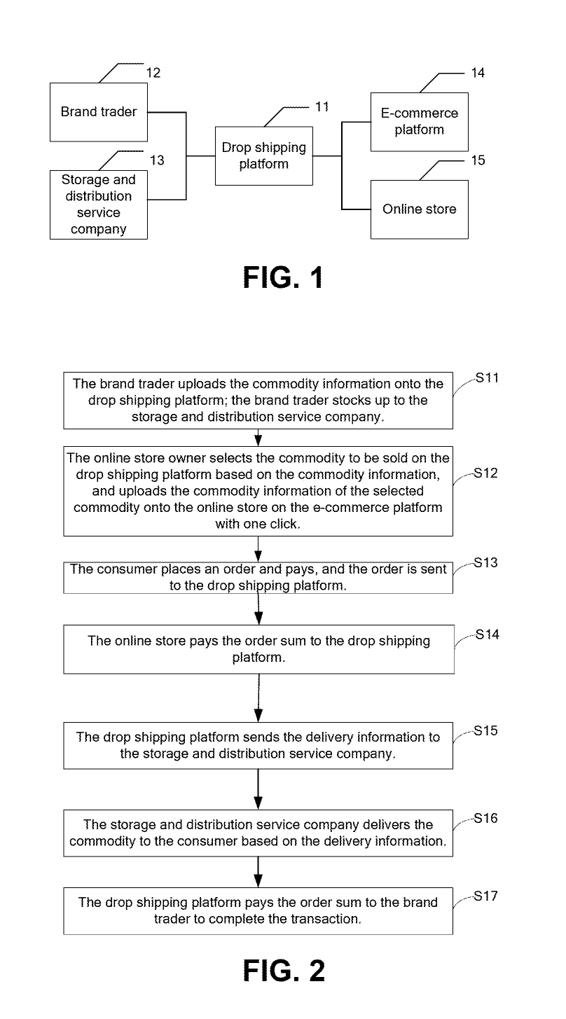

FIG. 1 is a schematic structural diagram of the drop shipping system in an embodiment; FIG. 2 is a schematic flow diagram of the drop shipping system in an embodiment. As shown in FIG. 1 and FIG. 2, a drop shipping system comprises drop shipping platform, a storage and distribution service company, online store, e-commerce platform and brand trader; said drop shipping platform communicates with the storage and distribution service company, online store, e-commerce platform and brand trader via an API interface;

S11: The brand trader uploads the commodity information onto the drop shipping platform; the brand trader stocks up to the storage and distribution service company;

As a preferred embodiment, Step S11 includes: The brand trader pushes the commodity ID to the drop shipping platform, and the commodity ID of said is correlated with the commodity information in advance.

As a preferred embodiment, the procedure that the brand trader stocks up to the storage and distribution service company in Step S11 includes: The drop shipping platform returns a commodity barcode based on the commodity information; the brand trader affixes the printed commodity barcode to the outer package of the commodity; the brand trader stocks the commodity affixed with the commodity barcode up to the storage and distribution service company; the storage and distribution service company updates the inventory information, and sends the updated inventory information to the drop shipping platform; the drop shipping platform reallocates the inventory based on the updated inventory information, and sends the latest inventory information to the e-commerce platform.

S12: The online store owner selects the commodity to be sold on the drop shipping platform based on the commodity information, and uploads the commodity information of the selected commodity onto the online store on the e-commerce platform with one click. As a preferred embodiment, Step S12 includes: It is judged if the commodity quantity of the current storage and distribution service company meets the preset quantity; if the commodity quantity of the current storage and distribution service company meets the preset quantity, the mall platform interfacing with the drop shipping platform will be differentiated; the commodity message is acquired based on all information of said commodity; the commodity message is synchronized with the corresponding online store on the e-commerce platform according to the criteria and requirements for commodity information of the e-commerce platform. The judgment that if the commodity quantity to be pushed in the current inventory meets the preset quantity also includes: If the commodity quantity to be pushed in the current inventory is less than the preset quantity, insufficient inventory is indicated, and the commodity to be pushed cannot be pushed. Said preset quantity is 10 pieces.

If the e-commerce platform is eBay, the procedure that the commodity message is acquired based on all information of said commodity includes: It is judged if the commodity is a multi-specification commodity based on all information of commodity; if yes, it is checked if the sub-item quantity of the commodity meets the preset quantity; if yes, a multi-specification message is assembled for the commodity; if no, a single-specification message is assembled for the commodity.

If the e-commerce platform is Amazon, the procedure that the commodity message is acquired based on all information of said commodity includes: It is judged if the commodity is a multi-specification commodity based on all information of commodity; if yes, it is checked if the sub-item quantity of the commodity reaches the preset quantity; if yes, main item and sub-item messages are assembled for the commodity; if no, a single-specification message is assembled for the commodity.

S13: The consumer places an order and pays, and the order is sent to the drop shipping platform;

As a preferred embodiment, Step S13 includes: The drop shipping platform pulls the paid order of the online store at the set time through the preset rules.

S14: The online store pays the order sum to the drop shipping platform;

S15: The drop shipping platform sends the delivery information to the storage and distribution service company;

As a preferred embodiment, Step S15 includes: The drop shipping platform converts paid orders of different online stores within the same period into sales orders; the drop shipping platform takes apart orders by brand traders to which commodities on sales orders belong; the drop shipping platform notifies the storage and distribution service company for delivery, obtains logistics tracking number, and pushes it to the online store.

S16: The storage and distribution service company delivers the commodity to the consumer based on the delivery information;

S17: The drop shipping platform pays the order sum to the brand trader to complete the transaction.

As a preferred embodiment, it also includes: The brand trader pays the distribution fee to the storage and distribution service company.

As a preferred embodiment, the procedure before Step S11 also includes: The online store logs into the e-commerce platform to push the authorization information to the drop shipping platform; the drop shipping platform accepts the authorization to tie in with the online store. When the e-commerce platform interfaces with GMDropship, the e-commerce platform is first registered on GMDropship, and the identification code of the e-commerce platform is sent to said drop shipping platform.

The above drop shipping system enables the brand trader to sell commodities under its own brand via a large number of B2C online stores through a series of information processing operations. The system uses API interfacing extensively, and integrates a number of third party platforms, such as storage management platform, logistics delivery platform, logistics tracking platform, online store platform, brand trader and payment gateway, into a complete distribution system; it also uses mobile devices and instant messaging to enable participants of all systems to work on the basis of automatic coordination, realizing a stable, efficient and accurate workflow. The system reduces labor costs and time, and improves economic efficiency by reducing manual handling. The system enables the brand trader to receive services from numerous online store owners by reducing working costs of online store owners dramatically.

The technical features of the above embodiments can be combined randomly. For the purpose of brief description, not all possible combinations of the technical features of the above embodiments have been described. However, as long as any combination of these technical features is not conflicting, it should be deemed to be included in these specifications.

The above embodiments represent several embodiments of the present invention only, and are described in greater detail, but should not be construed as a restriction on the scope of the present invention. It should be noted that some variations and improvements can be made without deviating from the conception of the present invention for ordinary technicians in the art, and fall into the scope of protection of the present invention. Therefore, the scope of protection of the present invention should be based on the attached claims.

What is claimed is:

1. A drop shipping system, its characteristic is that whereas it comprises drop shipping platform, storage and distribution service company, online store, e-commerce platform and brand trader;
Said drop shipping platform communicates with the storage and distribution service company, online store, e-commerce platform and brand trader via an API interface;
The brand trader uploads the commodity information onto the drop shipping platform; the brand trader stocks up to the storage and distribution service company;
The online store owner selects the commodity to be sold on the drop shipping platform based on the commodity information, and uploads the commodity information of the selected commodity onto the online store on the e-commerce platform with one click;
The consumer places an order and pays, and the order is sent to the drop shipping platform;
The online store pays the order sum to the drop shipping platform;
The drop shipping platform sends the delivery information to the storage and distribution service company;
The storage and distribution service company delivers the commodity to the consumer based on the delivery information;
The drop shipping platform pays the order sum to the brand trader to complete the transaction.

2. A drop shipping system according to claim 1, its characteristic is that whereas the procedure after the drop shipping platform pays the order sum to the brand trader also includes:
The brand trader pays the distribution fee to the storage and distribution service company.

3. A drop shipping system according to claim 1, its characteristic is that whereas the procedure that the brand trader uploads the commodity information onto the drop shipping platform includes:
The brand trader pushes the commodity ID to the drop shipping platform, the commodity ID of said is correlated with the commodity information in advance.

4. A drop shipping system according to claim 1, its characteristic is that whereas the procedure that the online store owner selects the commodity to be sold on the drop shipping platform based on the commodity information, and uploads the commodity information of the selected commodity onto the online store on the e-commerce platform with one click includes:
It is judged if the commodity quantity of the current storage and distribution service company reaches the preset quantity;
If the commodity quantity of the current storage and distribution service company meets the preset quantity, the mall platform interfacing with the drop shipping platform will be differentiated;
The commodity message is acquired based on all information of said commodity;
The commodity message is synchronized with the corresponding online store on the e-commerce platform according to the criteria and requirements for commodity information of the e-commerce platform.

5. A drop shipping system according to claim 1, its characteristic is that whereas the procedure that the order is sent to the drop shipping platform includes:
The drop shipping platform pulls the paid order of the online store at the set time through the preset rules.

6. A drop shipping system according to claim 5, its characteristic is that whereas the procedure that the drop shipping platform sends the delivery information to the storage and distribution service company includes:
The drop shipping platform converts paid orders of different online stores within the same period into sales orders;
The drop shipping platform takes apart orders by brand traders to which commodities on sales orders belong;
The drop shipping platform notifies the storage and distribution service company for delivery, obtains logistics tracking number, and pushes it to the online store.

7. A drop shipping system according to claim 1, its characteristic is that whereas the procedure that the brand trader stocks up to the storage and distribution service company includes:
The drop shipping platform returns a commodity barcode based on the commodity information;
The brand trader affixes the printed commodity barcode to the outer package of the commodity;
The brand trader stocks the commodity affixed with the commodity barcode up to the storage and distribution service company;
The storage and distribution service company updates the inventory information, and sends the updated inventory information to the drop shipping platform.

8. A drop shipping system according to claim 7, its characteristic is that whereas the procedure after the storage and distribution service company updates the inventory information, and sends the updated inventory information to the drop shipping platform also includes:
The drop shipping platform reallocates the inventory based on the updated inventory information, and sends the latest inventory information to the e-commerce platform.

9. A drop shipping system according to claim 1, its characteristic is that whereas the procedure before the step that the online store owner selects the commodity to be sold on the drop shipping platform based on the commodity information also includes:
The online store logs into the e-commerce platform to push the authorization information to the drop shipping platform;
The drop shipping platform accepts the authorization to tie in with the online store.
